(19) United States
(12) Patent Application Publication
(10) Pub. No.: US 2023/0204878 A1
(43) Pub. Date: Jun. 29, 2023

(54) PHOTONICS PACKAGE INCLUDING OPTIC PLUG RECEPTACLE WITH SUPPORT PORTION FOR PHOTONICS INTEGRATED CIRCUIT AND LENS ASSEMBLY

(71) Applicant: Intel Corporation, Santa Clara, CA (US)

(72) Inventors: Wesley B. Morgan, Lake Oswego, OR (US); Sufi R. Ahmed, Chandler, AZ (US); Vineeth Abraham, Phoenix, AZ (US); Sivakumar Yagnamurthy, Chandler, AZ (US); Xiaoqian Li, Chandler, AZ (US); Srikant Nekkanty, Chandler, AZ (US)

(73) Assignee: Intel Corporation, Santa Clara, CA (US)

(21) Appl. No.: 17/560,847

(22) Filed: Dec. 23, 2021

(51) Int. Cl. G02B 6/42

(52) U.S. Cl. CPC G02B 6/4212; G02B 6/4239; G02B 6/4243

(57) ABSTRACT

A receptacle of a photonics package, a receptacle assembly including the receptacle, the photonics package, and a method of making the receptacle assembly. The receptacle assembly comprises: a photonics integrated circuit (PIC) including waveguides thereon; a die side lens assembly; and a rigid receptacle body including: a plug portion to receive an optical plug that includes a plug side lens assembly; a lens portion supporting the die side lens assembly and configured such that the die side lens assembly and the plug side lens assembly are aligned to one another when the optical plug is received in the plug portion; and a PIC portion bonded to the PIC such that the waveguides of the PIC are aligned to: corresponding lenses of the die side lens assembly; and corresponding lenses of the plug side lens assembly when the optical plug is received in the plug portion.

### GOVERNMENT LICENSE RIGHTS

This invention was made with Government support under Agreement No. HR0011-19-3-0003-00-0-0000-0122, awarded by DARPA. The Government has certain rights in the invention.

### TECHNICAL FIELD

Embodiments of the present disclosure relate to electronic packages, and more particularly to receptacles adapted to receive optical connectors therein for expanded beam coupling in on-package optics.

### BACKGROUND

The microelectronic industry has begun using optical connections or optical connectors at the ends of fiber optic cables having plugs as a way to increase bandwidth and performance. The optical connectors include plug-side lens assemblies that must align with tight tolerances to corresponding die-side lens assemblies that are to guide light form PICs to the fiber optic cables through the plug-side lens assemblies. In addition, the PICs must align with tight tolerances to the die-side lens assemblies. A photonic package includes multiple components made of materials with varying coefficients of thermal expansion (a substrate, and, on the substrate, at least a PIC, a die-side lens assembly, a receptacle to receive a plug therein, and sometimes a processor from which signals are to travel through the PIC and emerge as light beams travelling through the die-side lens assembly toward the plug inserted into the receptacle. During operation, a photonic package may cycle through a range of temperatures that may cause warpage of the substrate, potential warpage of any of the components thereon, and that hence may compromise the alignment between PIC and die-side lens assembly, and/or die-side lens assembly and plug-side lens assembly. Misalignment between components of a photonics package may compromise the performance of the photonics package in communicating signals to and from a processor using such package. Mechanisms are needed to address the above disadvantages of the state of the art.

### BRIEF DESCRIPTION OF THE DRAWINGS

FIG. 1 is a perspective view illustration of a photonics package according to the state of the art.

FIG. 2 is a perspective view illustration of an extended receptacle subassembly including a die-side lens thereon according to an embodiment.

FIG. 3A is a perspective view illustration of an extended receptacle assembly including the extended receptacle subassembly of FIG. 2 and a photonics die or photonics integrated circuit (PIC) coupled thereto, according to some embodiments.

FIG. 3B is a view similar to FIG. 3A, but showing an architecture according to some embodiments.

FIG. 4 is a cross-sectional illustration of an assembly including a PIC supported by a pickup tool fixture and in the process of being aligned to an extended receptacle subassembly similar to the extended receptacle subassembly of FIG. 2, according to some embodiments.

FIG. 5 is a perspective view illustration of the assembly of FIG. 4.

FIG. 6 is top plan view illustration of the assembly of FIG. 4.

FIG. 7A is a cross sectional view of a carrier fixture temporarily carrying a number of PICs thereon at one stage of a process for wafer level assembly of a number of PICs to corresponding extended receptacles, according to one embodiment.

FIG. 7B is a cross sectional view of a wafer of extended receptacles bonded to the PICs on the carrier fixture of FIG. 7A at a subsequent stage of a process for wafer level assembly of a number of PICs to corresponding extended wafers according to one embodiment.

FIG. 8 illustrates a computing system in accordance with one implementation of embodiments, such as those described in relation to FIGS. 1-7B,

FIG. 9 is a flow chart depicting a process according to some embodiments.

### EMBODIMENTS OF THE PRESENT DISCLOSURE

Described herein are embodiments of an extended receptacle with a support feature for a PIC to allow more reliable beam coupling for on-package optics. On-package optics in general provide a faster alternative than electrical signals for communication between processors, such as CPUs or XPUs, and other components within a computing system, such as a memory or storage device. However, photonics packages, which include substrate, typically made of epoxy or glass, and other components thereon, in general containing silicon, can suffer from warpage caused by electrons travelling through copper wires of the substrate. The warpage is brought about by a heating of the substrate as a result of typical temperature cycling of the photonics package under routine operating conditions. Because of a coefficient of thermal expansion (CTE) mismatch between the substrate and the components thereon, including the PICs, the lens assembly, and the receptacle that is to receive optical connectors, a warpage of the substrate causes misalignment of the light emanating from the PICs, travelling through the lens assembly, and being collected by the plugs supported within the receptacle. For example, a substrate may have a CTE in the range of about 30 Gpa, although a receptacle for example may have a CTE of about 5-8 Gpa. When the substrate warps, for instance, the PIC and the lens may travel with the warpage of the substrate in a given x-y-z (linear) direction and a given angular direction, while the receptacle (and hence the plug received therein, including plug side lens assembly) may travel in a different linear and/or angular direction. A misalignment may cause an interruption or an attenuation of the light signal, adversely impacting performance.

In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Embodiments disclosed herein include a receptacle configured to receive optical connectors therein for expanded beam coupling in on-package optics, where the receptacle includes a support feature to support one or more PICs thereon. A receptacle according to some embodiments is extended, in that, in addition to including an optical connector receiving portion to receive an optical connector therein, it includes a PIC support portion and a lens support portion that forms a rigid extension to the optical connector receiving or plug portion. The PIC support portion and a lens support portion of the extended receptacle advantageously allows for sustained and improved alignment during operation of the photonics package. With a receptacle according to embodiments, even though the substrate of a photonics package may be warping through temperature cycling as a result of normal operating conditions, there would be relatively little movement between the lens assembly attached to the receptacle, and the waveguides of the PIC. The PIC, the lens assembly, and the plugs would ride along any warpage of the substrate together.

A package integrated plug extended receptacle according to embodiments will have tight alignment to a PIC having an expanded beam lens assembly attached to its edge with fine alignment to the photonic waveguides of the PIC throughout operation and temperature cycling of the photonics package.

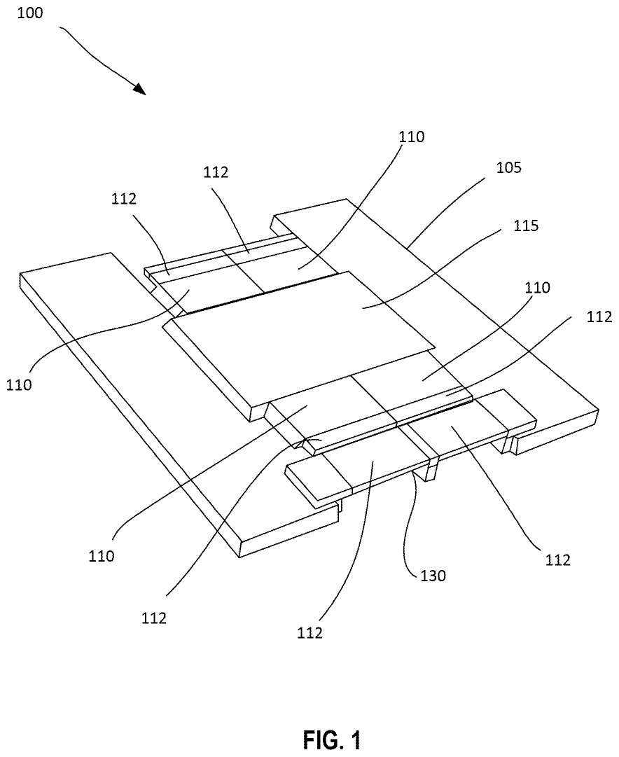

Referring now to FIG. 1, a perspective view illustration of a photonics package 100 according to the state of the art. The photonics package 100 comprises a package substrate 105. The package substrate 105 may comprise conductive features (e.g., traces, pads, vias, etc.) for providing electrical routing in the photonics package 100. In an embodiment, an edge of the package substrate 105 may comprise a cutout. The cutout may be filled by plug receptacle 130. The substrate may include layers of glass and/or epoxy within which the conductive features are disposed.

In an embodiment, a plurality of PICs 110 may be provided over the package substrate 105. The edge of the PICs 110 may be provided along a recessed edge of the cutout in the package substrate 105. The edge surfaces of the PICs 110 may be placed adjacent respective lens assemblies 112, with each lens assembly including one or more lens arrays.

As can be seen in FIG. 1, the PICs 110 must align with tight tolerances to the die-side micro lens assemblies (lens assemblies) 112, and specifically to the lens arrays of those lens assemblies. In addition, the lens assemblies 112 must align to the receptacles 130 such that, when optical connectors are inserted therein, plug side lens arrays align with tight tolerances to corresponding ones of the lens arrays of lens assemblies 112. The substrate 105, typically made of epoxy and glass with conductive features therein, typically has a coefficient of thermal expansion (CTE) that is order of magnitude larger than that typically associated with the PICs, the receptacles and the lens assemblies. During operation, the photonics package 100 cycles through a range of temperatures that may cause warpage of the substrate 105, potential warpage of any of the components thereon, and that hence may compromise the alignment between PICs 110 and die-side lens assemblies 112, and/or die-side lens assemblies 112 and plug-side lens assemblies to be plugged into the receptacles 130. Misalignment between components of a photonics package may compromise the performance of the photonics package in communicating signals to and from the processor 115. For example, state of the art solutions such as the one shown in FIG. 1 can be incapable of meeting optical loss targets across a wide operating temperature range required for server packages (e.g., from about −40 C to about 100 C).

It is cumbersome to optimize smaller knobs in architectures to achieve misalignment targets. A bigger knob to control misalignment is needed to mitigate the misalignment issues noted above.

The misalignment problem is exacerbated by the fact that Known Good Die (KGD) testing generally happens before the final optical attach assemblies are completed, such as before receptacle attach, which fact increases the risk of yield loss due to misalignment during or after receptacle attach to the package.

In addition to the misalignment problem noted above, the edge coupling of a lens assembly to a PIC requiring optical grade refractive index matching adhesives, for example in a state-of-the-art example such as the one shown in FIG. 1, carries a high risk of contamination by overflow of the mechanical adhesive into the optical path, impacting optical performance.

When a lens assembly, such as lens assembly 112, is attached to a PIC in an edge attach orientation as shown in FIG. 1, the lens assembly alignment fiducials are pointed orthogonally and not in view of a top-down vision system looking at a PIC fiducial, and are therefore not compatible with standard attach equipment. As a result, lens assembly attach for a photonics package configuration of FIG. 1 would require a more complex, slower, and less reliable assembly process than those provided by standard attach equipment.

Current attach processes may include active alignment attach of lens assemblies to PIC sidewalls, followed by a receptacle attach to the substrate using active/passive alignment, although passive attach techniques are sometimes also used. There is currently no standard industry technique for expanded beam implementation for edge coupled PICs.

Additionally, in current attach processes, the lens assembly has mechanical adhesive only along its edges, and is attached to only a sidewall of the PIC. The state of the art does not provide physical support for the bottom of the lens assembly. The above, however, can result in the lens assembly shifting during post optical attach processes resulting in signal loss. Additionally, thermo-mechanical reliability of a lens assembly bonded to a PIC is dependent on the extent of the mechanical adhesive bonding area. Current techniques use mechanical epoxy on a small region of an interface between the lens assembly and PIC, and could therefore pose reliability issues. In addition, since there is no physical support at the bottom of the lens assembly, during an adhesive dispense stage of fabrication of the photonics package, excessive adhesive may flow past the lens assembly and contaminate the package.

Some embodiments provide a receptacle of a photonics package, a receptacle subassembly including the receptacle, a receptacle assembly including the receptacle subassembly, the photonics package, and a method of making the receptacle assembly. The receptacle assembly comprises: a photonics integrated circuit (PIC) including waveguides thereon; a die side lens assembly; and a rigid receptacle body including: a plug portion to receive an optical plug that includes a plug side lens assembly; a lens portion supporting the die side lens assembly and configured such that the die side lens assembly and the plug side lens assembly are aligned to one another when the optical plug is received in the plug portion; and a PIC portion bonded to the PIC such that the waveguides of the PIC are aligned to: corresponding lenses of the die side lens assembly; and corresponding lenses of the plug side lens assembly when the optical plug is received in the plug portion.

Embodiments provide a more robust platform for lens attach stability as compared with the state of the art, fewer assembly steps and faster throughput of package assemblies with object input-output ingredients.

According to some embodiments, the lens assembly may be mounted on the receptacle 230 with controlled alignment therebetween.

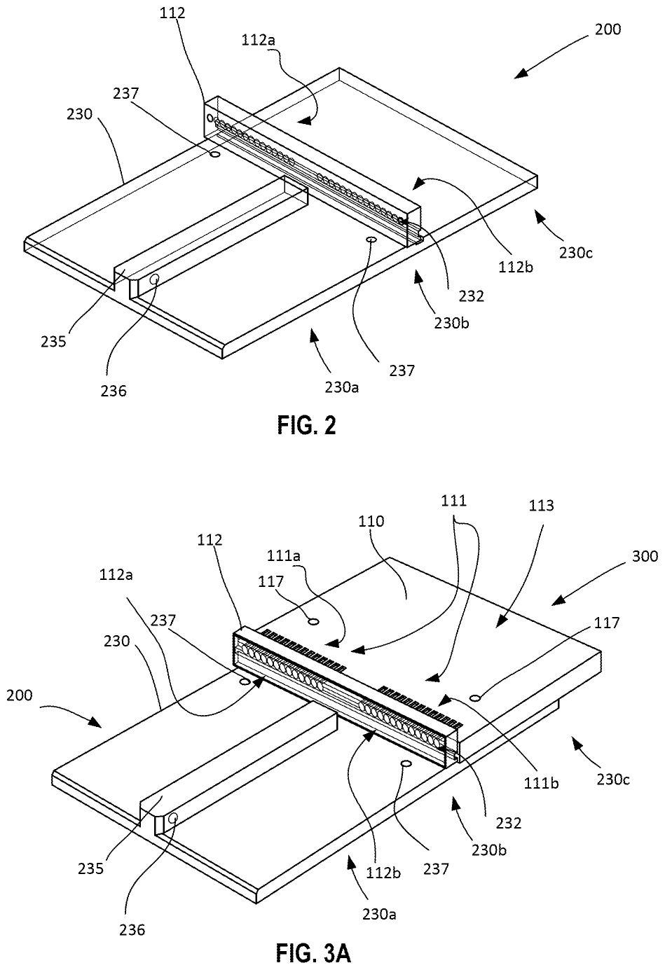

FIG. 2 shows a perspective view of a receptacle subassembly 200 including an extended receptacle 230 having a plug portion 230a, a lens support portion 230b and a PIC support portion or feature 230c, portions 230a-230c forming a rigid body of the receptacle together. It is noted that, in FIG. 2, like components as compared with the components of FIG. 1 have been referred to with like reference numerals. The receptacle subassembly 200 includes, in addition to the extended receptacle 230, the die-side lens assembly 112 attached thereto. The lens assembly 112 may include two lens arrays 112a and 112b, although any number of lens arrays are possible for a lens assembly to be used in a receptacle assembly according to some embodiments.

The extended receptacle may include a rigid material, for example metal. A metal-based receptacle will advantageously help to improve thermal performance of the PIC die. The receptacle may provide the three mechanical interfaces for an expanded beam optical connector system to be made part of a photonics package as mentioned previously, that is, the plug support portion or plug portion 230a, the lens support portion or lens portion 230b and the PIC support portion or PIC portion 230c, together forming a rigid body of the receptacle. The PIC support portion may be adapted to be bonded to an integrated heat spreader of a photonics package, in this manner accommodating thermal contact and between the PIC and the heat spreader.

The receptacle rigid body may include an ultraviolet (UV) transparent material to enable use of a UV adhesive for bonding to the PIC, or the receptacle rigid body could include a metal that can be bonded to the PIC with high temperature solder or other thermal based bonding technique which would help in PIC heat dissipation. The receptacle body may be made of a combination of materials and/or a combination of different parts that are joined together, with one part of the receptacle rigid body including a metal, and another part including a UV transparent material.

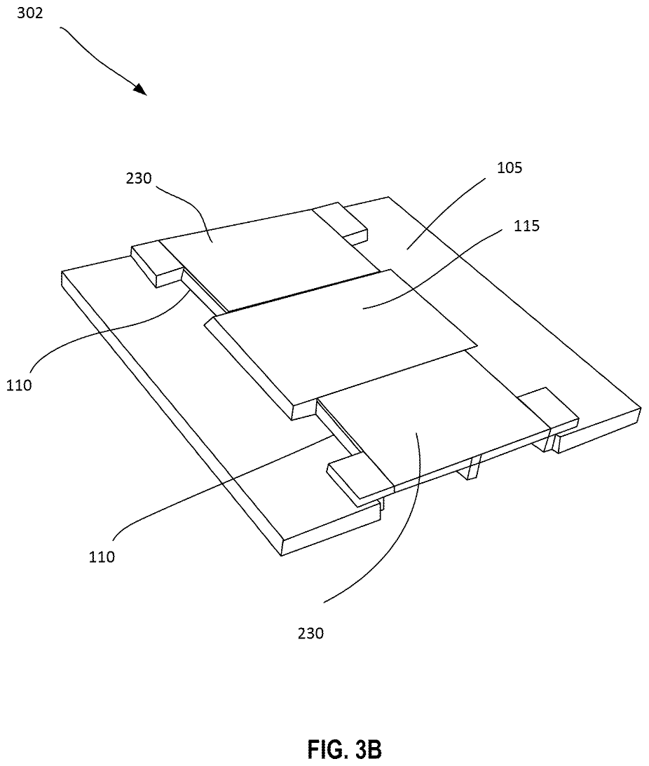

The lens arrays may comprise a plurality of lenses that are to be aligned with an optical waveguide in a PICs to be attached to the support feature 230b, as will be explained in relation to FIG. 3 below. The lenses may be collimating lenses that expand the beam from the optical waveguide of a corresponding PIC.

The die side lens assembly 112 and a plug side lens assembly allow for the optical beam to be collimated and expanded at the die-plug interface, providing expanded beam coupled for in-package optical communication. The larger optical beam allows for improved alignment tolerances and allows for improved yields, although tight alignment between components of the photonics package would still be required.

The die side and plug side lens arrays may comprise an optically clear material, such as glass. Individual lenses of the arrays may be formed on the die side lens arrays and individual lenses may be formed on the plug side lens arrays.

The plug portion 230a corresponds to a region of receptacle 230 to receive a plug, and may include plug alignment features such as rib 235 (to provide gross alignment of the plug) and fiducials 236 on the tongue or rib. The plug alignment feature may interface with a complementary feature on the plug, such as, in the case of the shown embodiment of FIG. 2, a groove defined in the plug. The receptacle may further include additional fiducials 237 thereon for finer alignment with the lens assembly 112, and with the PIC to be supported thereon. One plug portion is shown in the receptacle embodiment of FIG. 2. Each plug portion is to align a plug to a corresponding PIC.

Although the embodiment of the extended receptacle 230 of FIG. 2 shows a receptacle subassembly that includes one lens assembly, and that is configured to support one plug and one corresponding PIC, embodiments are not so limited. In an embodiment, a single extended receptacle may have a plug portion that is to receive multiple plugs, a lens support portion that is to support multiple corresponding lens assemblies, and/or a support feature that is to support multiple corresponding PICs. Where multiple plugs are to be received in a single extended receptacle, subregions for receiving individual plugs may be separated from each other by walls used to guide the plugs into the receptacle 230.

Although the embodiment of the extended receptacle 230 of FIG. 2 shows a receptacle subassembly that includes a lens assembly attached to the receptacle rigid body, embodiments are not so limited, and include within their scope a receptacle subassembly where the lens and the receptacle rigid body are a unitary or one-piece structure. This, according to embodiments, the lens assembly may therefore either be bonded to the receptacle, or be unitary with the receptacle rigid body.

In the receptacle subassembly 200, the bonding surface of the lens support portion 230b may include any suitable adhesive thereon that is in registration with a corresponding bonding surface of the lens assembly. No adhesive is disposed in the receptacle subassembly that may interfere with the light path

A first end of an optical fiber may be located within each plug, and may terminate at a plug side lens array, which, as noted above, is to be aligned with a die side lens array. As such, optical signals from the optical fiber may be propagated to the PIC 110 and vice versa. A plug may also comprise a latching mechanism that interfaces with a latch anchor (not shown) on the receptacle 230. Additionally, a portion of a spring on the plug may extend substantially along a length of a housing of the plug. One or more optical fibers may be provisioned in each plug. For example, an eight-fiber plug, a sixteen-fiber plug, or a twenty-four-fiber plug may be used in some embodiments.

FIG. 3A shows a view similar to that of FIG. 2, and illustrates a receptacle assembly 300 that includes, on the one hand, the receptacle subassembly 200 of FIG. 2, and, in addition, a PIC 110 attached to the PIC and lens support feature 230b thereof.

The PIC 110 may be any suitable PIC. Particularly, the PIC may include functionality to convert an optical signal to an electrical signal and/or to convert an electrical signal to an optical signal. In an embodiment, optical signals are received by or propagated from optical waveguides embedded in the PICs. The one or more lens arrays 112 allow for external optical coupling with an optical connector.

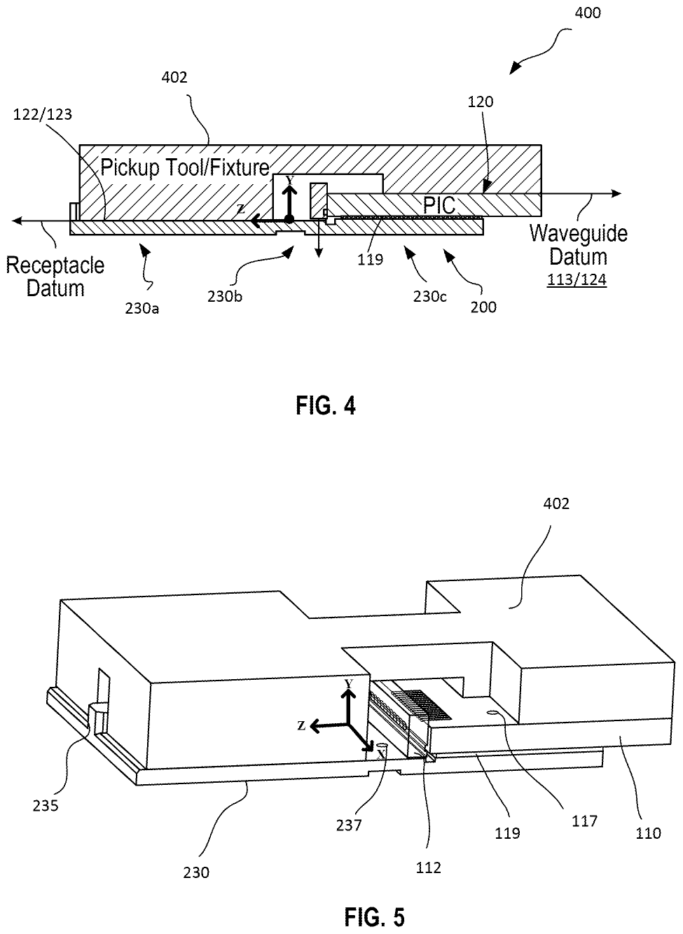

The PIC 110 may be bonded to the receptacle 230 using any suitable manner of bonding, such as epoxy 119 or other adhesive. The PIC may be mounted onto the receptacle 230 in any number of ways, for example by using a pick-up tool as will be explained below in relation to FIGS. 4-6, or through a wafer level assembly, as will be described further below. The PIC 110 is to be mounted onto the receptacle 230, and specifically to the receptacle support feature 230b, such that it is aligned to the lens arrays of the lens assembly 112 by way of its waveguides 111 and by way of additional fiducials thereon, such as fiducials 117. Specifically, waveguides 111a and 111b and/or fiducials 117 of PIC 110 may be used to align the PIC to the respective lens arrays 112a and 112b of lens assembly 112 and hence to the extended receptacle 230.

In order to properly align the lens assembly 112 to the PIC 110, and to a plug to be inserted into the receptacle 230, fine alignment features may also be provided on the lens assembly 112, such as fiducials 232 as shown. In addition, or in the alternative, posts may be provided on the die side lens array to accommodate holes for receiving the posts on the plug side lens array. In other embodiments, the posts may be provided on the plug side and the holes may be provided on the die side.

After the PIC 110 is mounted to the receptacle subassembly to form the receptacle assembly 300, the receptacle assembly 300 may be mounted onto a package substrate, such as substrate 105 of FIG. 1, by virtue of the exposed surface 113 (surface of the PIC opposite its receptacle side surface) of the PIC 110 being attached to and electrically coupled to the substrate through electrical features thereof. For example, conductive traces on the upper surface of the substrate may be bonded to electrical features, such as contacts, at the exposed surface of the PIC 110, for example using solder bonds, or any other suitable manner of bonding. Once the receptacle assembly 300, including the PIC 110 and the lens assembly 112, is turned over and mounted onto the substrate 105, the support feature of the receptacle will be rigidly attached to and extend over a portion of a top (receptacle-side) surface of the PIC.

FIG. 3B is a view similar to that of FIG. 1, but showing a photonics package 302 that includes, instead of receptacles 130 of FIG. 1, extended receptacles 230 as part of receptacle assemblies 300 such as those shown and described in the context of FIG. 3A above. Photonics package 302 may be made part of a photonics system that further includes a socket and a lid for the photonics package 302. The socket may be coupled to a board of a computing system, such as, by way of example, the one shown in FIG. 7.

A direct bonding of both the lens assembly 112 and the PIC 110 to the extended receptacle 230 that is configured to receive a plug therein helps to mitigate the misalignment problem caused by substrate warpage. The extended receptacle allows both the PIC, the die side lens assembly and the plug side lens assembly to move together in the case of a warpage of the substrate.

This receptacle assembly 300 may then be used for PIC attach to substrate to form a photonics package such as the one shown in FIG. 7 after known good die (KGD) testing with no additional optical coupling stages required, resulting in a true known good optical performance from the PIC. This receptacle of assembly 300 could later be bonded to an integrated heat spreader or other rigid structures of the photonics package to prevent transfer of force to the PIC and its interconnects during attach or detach of a plug. Bonding of the receptacle to the substrate may be achieved using high thermally conductive epoxy or other suitable adhesive.

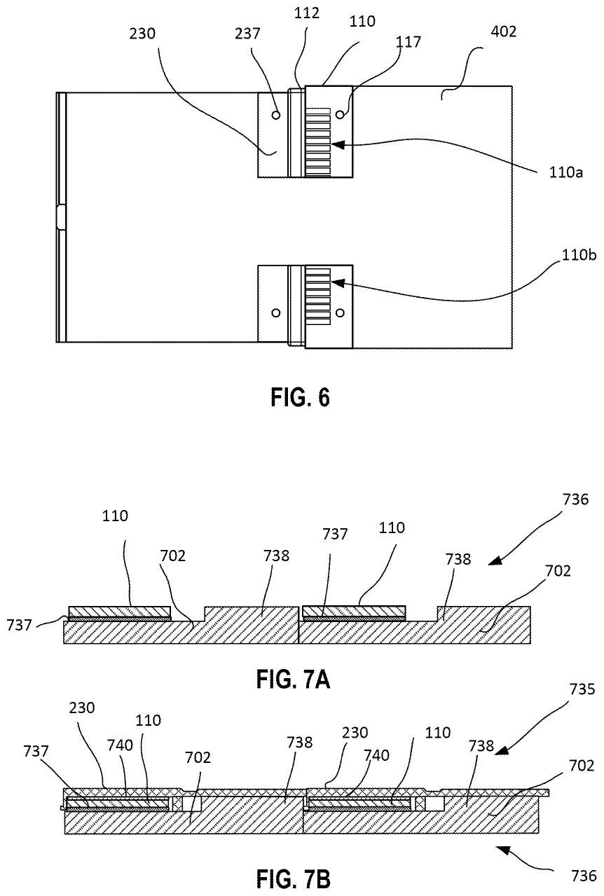

FIGS. 4-6 below show various views of a temporary assembly 400 including a pick-up tool 402 attached to PIC 110 and in the process of being used to mount the PIC to the extended receptacle 230 in an aligned manner. FIG. 4 shows a cross section of the temporary assembly 400, FIG. 5 shows a perspective view of the temporary assembly 400, and FIG. 6 shows a top plan view of the temporary assembly 400.

As shown in FIGS. 4-6 show the receptacle subassembly 200 of FIG. 2 in the process of being attached to PIC 110 to make the receptacle assembly 300 of FIG. 3.

The pick-up tool 402 may be used, according to one embodiment, to ensure fine alignment of the PIC and its waveguides to the lens assembly 112 in the final assembly 300 through an active alignment process, although other methods of assembly are also possible. The pick-up tool may temporarily attach the PIC 110 to itself at the exposed surface 113 of the PIC for example using a vacuum attachment at 120. A receptacle datum 122 of the tool is to be precisely micromachined to submicron accuracy to align with an exposed/top surface 123 of the receptacle 230 that holds a plug-in position. A waveguide datum 124 of the PIC 110 tool is to be precisely micromachined to submicron accuracy to align with exposed surface 113 of PIC 110.

Fiducials on the receptacle subassembly, such as fiducials 237, fiducials on the lens, such as fiducials 232, and additional fiducials on the PIC, such as fiducials 117, may be used to align the PIC to the receptacle. For example, the pick-up tool 402 may be used, for example in an automated way using a robot and a camera, to reference the fiducials in order to achieve a linear alignment (e.g., in the x and in the z directions as shown). The pick-up tool 402 would allow an angular alignment about the y axis, as well as linear alignment about the x-y-z axes. It is to be noted that the thickness of a PIC is in general not tightly controlled. As a result, use of the receptacle datum in conjunction with the waveguide datum would provide a good alignment of the PIC with the lens assembly attached to the receptacle regardless of any gap between the PIC and the receptacle, which gap would include for example an adhesive, such as epoxy. The PIC may include regions thereon designed for the pick-up tool to contact, such as wear pads or contact points. An automated vision/camera-based alignment system may include the pick-up tool, and may use feedback from a camera, based on the fiducials mentioned above, to help the automated system align the pick-up tool to the PIC and to the receptacle in the manner shown. For example, the pick-up tool 402 may first align itself to the PIC using fiducials on the PIC, attach itself to the PIC, and then align itself to the receptacle using the fiducials provided on the receptacle. Once the latter fiducials are located and the PIC begins to touch down on the receptacle, the automated system may use the waveguide datum and the receptacle datum as noted above to ensure fine alignment of the PIC to the receptacle. The shown embodiment of the pick-up tool is one of a top-mounted vision-based system according to an embodiment, with the pick up tool reference datum enabling control of all of the remaining linear axes and angles.

Once the receptacle assembly is assembled, for example using a pick up tool, or using another manner of assembly, a plug may be inserted into the receptacle.

In addition to or instead of the fiducials on the PIC and receptacle providing visual alignment features, mechanical alignment features, such as one or more tongue and groove structure, or other mechanical features, such as alignment posts on one component (receptacle or PIC), and matching gaps on another component (PIC or receptacle), may be incorporated on the PIC and receptacle such that the mechanical features can interact with one another in order to ensure fine alignment of the PIC to the receptacle.

According to an embodiment. A process flow for using a pick-up tool for die level assembly of a PIC to a receptacle a pick-up tool with precision edges, such as pick up tool 402 of FIG. 4, may be used to align with the PIC fiducials, and pick up the PIC with good contact with waveguide datum 124 (see FIG. 4). Adhesive may then be pre-dispensed on the receptacle on the PIC support portion 230c thereof, and the pick-up tool with PIC bonded thereto may be aligned to the receptacle fiducials. The receptacle 230 may then be picked up by the pick-up tool in alignment with the receptacle datum 123 (see FIG. 4), and the adhesive under the PIC may be cured using a UV cure to bond the PIC to the receptacle.

This design and approach of bonding a receptacle directly to a PIC will aid in reducing the linear and angular misalignment between the plug side lenses and the PIC side lenses when a plug is inserted into the receptacle at its plug support portion.

Analysis has shown a significant improvement in alignment using examples of embodiments.

FIGS. 7A and 7B show cross sectional views of stages in a process for wafer level assembly of a number of PICs to corresponding extended receptacles according to some embodiments, as an alternative to the pick-up tool option for individual PICs noted above with respect to FIGS. 4-6 above.

As shown in FIG. 7A, a carrier fixture 736 could be provided including multiple adjacent carrier platforms 702. Each carrier platform 702 could be provided with temporary adhesive 737 to be temporarily bonded to a PIC thereon on exposed surfaces of the PICs, such as exposed surface 113 of PIC 110 of FIGS. 2-6.

As shown in FIG. 7B, a wafer 735 could be provided including multiple adjacent elongated receptacles in rows and columns, each receptacle for example similar to receptacle 230 of FIG. 2. The PICs 110 on the carrier fixture 702 on the one hand, and the corresponding receptacles 230 of wafer 735 on the other hand, could then be placed in registration with one another, and the PICs then released from the platforms 702 (by releasing the PICs from the temporary adhesive) and bonded, for example with an adhesive 740, to the corresponding receptacles, for example using epoxy or another adhesive. The fixture 736 could therefore function similarly to the pick-up tool shown in FIGS. 4-6, except that it would be aligned to and be used to align multiple PICs to a wafer of receptacles.

As shown in FIGS. 7A and 7B, the fixture 702 may include height control pedestals 738 that could be used to support the PICs thereon with temporary adhesive. The height control pedestals 737 may be used to provide precise height control with respect to the PICs, such that, when the PICs are placed onto the wafer 702, the PICs can contact the receptacles. Similar to the pick-up tool 402 of FIGS. 4-6, an automated vision/camera-based alignment system may be used to locate the fiducials on the PICs and align the PICs to the platform 735, and then to locate fiducials on the wafer 702 to locate the PICs to their corresponding receptacles. Epoxy between the PICs and their receptacles would compensate for any height differences between the PICs. Additional pedestals on the platform 735 may further be used for gross adjustment of the PICs over the wafer 702. After PIC placement and release, the wafer and PICs assembled thereon can then be batch cured, or the receptacle assemblies singulated and individually cured.

According to the example embodiments described above, alignments may be implemented with a top mounted vision-based automated systems that are available on currently existing mounting devices. This technique also eliminates the need for doing signal based active alignment of the lens assembly or receptacle to the waveguides on the PIC, which will make the assembly and alignment process faster, simpler and more efficient.

Embodiments substantially mitigate a misalignment between a plug inserted in the receptacle, the lens assembly and the PIC as a result of thermal variations seen by the package during operation.

Some embodiments provide a method to test the optical alignment and attach quality of the receptacle assembly before it is committed to a package, which provides tremendous yield and cost advantage in packaging.

Optical attach processes according to some embodiments are simpler and faster with a single component, that is, with the receptacle subassembly, such as assembly 200, being attached to the PIC using vision-based alignment system. Since, according to some embodiments, the receptacle is attached directly to the PIC, a plug that is secured to the receptacle will follow the lens assembly attached to the PIC during movement of the lens assembly as a result of warpage of the substrate supporting the same at different operating temperatures of the corresponding photonics package. Linear and angular misalignments due to CTE mismatch are further significantly minimized with the use of embodiments.

Some embodiments enable passive lens attach to a PIC by adding passive alignment features compatible with standard pick and place processes via offline receptacle/lens assembly process. PIC attach according to embodiments may be at PIC level or at wafer level, and may enables test for known good die/stack/lens prior to committing the assembly to a package.

Some embodiments provide alignment fiducials that are top view visible on both the PIC and one the receptacle subassembly. Some embodiments provide a PIC support portion of a receptacle that presents an area for surface-to-surface physical contact for enabling accurate placement of a PIC thereon in linear and angular alignment of the PIC waveguides with the lens array.

Some embodiments provide a design that allows a more robust lens assembly to PIC attach platform.

Some embodiments provide a means to keep optical and mechanical adhesives separated on the receptacle assembly to prevent contamination of the light path with adhesive by way of adhesive overflow.

Some embodiments provide fiducial type alignment features for top-down vision/camera alignment and attach automated systems.

Some embodiments improve the linear and angular alignment between the PIC waveguides, the die side lens assembly and the plug side lens assembly, further providing a rigid body or receptacle platform for PIC attach that is also platform for plug alignment, reducing the tolerance stack.

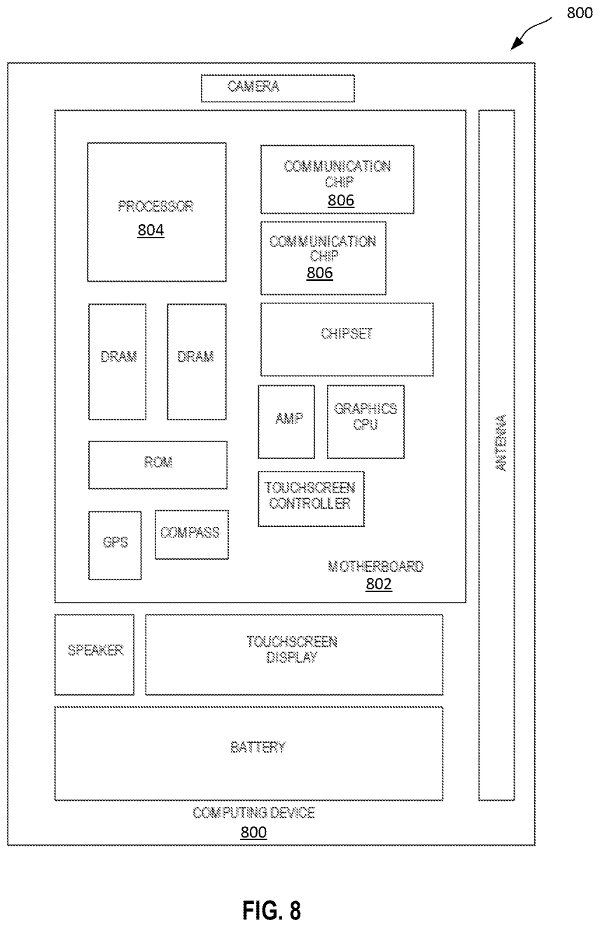

FIG. 8 illustrates a computing system 800 in accordance with one implementation of embodiments, such as those described in relation to FIGS. 1-7B above. The computing system 800 houses a board 802. The board 802 may include a number of components, including but not limited to a processor 804 and at least one communication chip 806. The processor 804 is physically and electrically coupled to the board 802. In some implementations the at least one communication chip 806 is also physically and electrically coupled to the board 802. In further implementations, the communication chip 806 is part of the processor 804.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 806 enables wireless communications for the transfer of data to and from the computing system 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 806 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing system 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

The processor 804 of the computing system 800 includes an integrated circuit die packaged within the processor 804. In some implementations of the invention, the integrated circuit die of the processor may be part of a photonics system that comprises a receptacle to enable a pluggable optical connection, in accordance with embodiments described herein. The term “processor” may refer to any device or portion of a device that processes electronic data from registers and/or memory to transform that electronic data into other electronic data that may be stored in registers and/or memory.

The communication chip 806 also includes an integrated circuit die packaged within the communication chip 806. In accordance with another implementation of the invention, the integrated circuit die of the communication chip may be part of a photonics system that comprises a receptacle to enable a pluggable optical connection, in accordance with embodiments described herein.

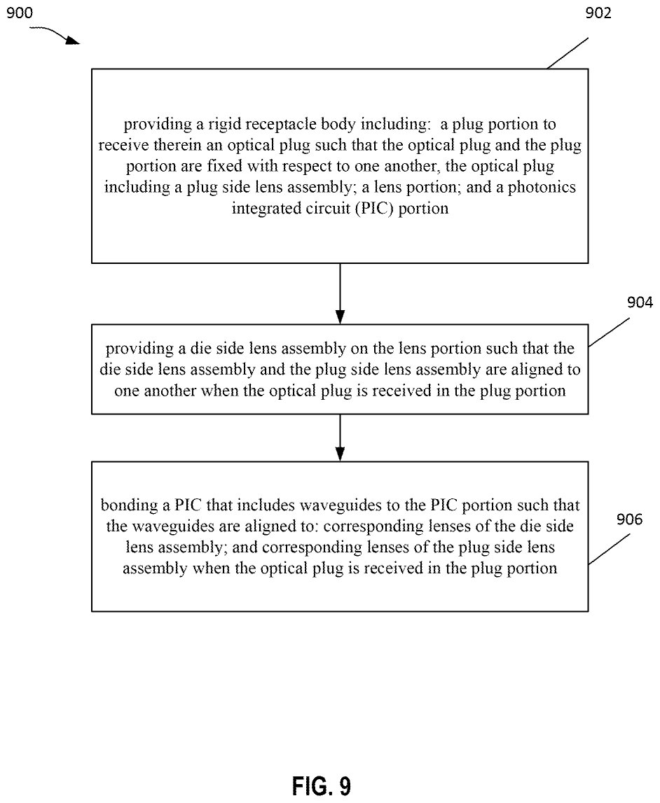

FIG. 9 illustrates a flow of a process 900 according to some embodiments. Operation 902 includes providing a rigid receptacle body including: a plug portion to receive therein an optical plug such that the optical plug and the plug portion are fixed with respect to one another, the optical plug including a plug side lens assembly; a lens portion; and a photonics integrated circuit (PIC) portion. Operation 904 includes providing a die side lens assembly on the lens portion such that the die side lens assembly and the plug side lens assembly are aligned to one another when the optical plug is received in the plug portion. Operation 906 includes bonding a PIC that includes waveguides to the PIC portion such that the waveguides are aligned to: corresponding lenses of the die side lens assembly; and corresponding lenses of the plug side lens assembly when the optical plug is received in the plug portion.

Although an overview of embodiments has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of embodiments has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

In embodiments, the phrase “A is located on B” or “A is on B” means that at least a part of A is in direct physical contact or indirect physical contact (having one or more other features between A and B) with at least a part of B.

In the instant description, “A is adjacent to B” means that at least part of A is in direct physical contact with at least a part of B.

In the instant description, “B is between A and C” means that at least part of B is in or along a space separating A and C and that the at least part of B is in direct or indirect physical contact with A and C.

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” “according to some embodiments,” “in accordance with embodiments,” or “in embodiments,” which may each refer to one or more of the same or different embodiments. Furthermore, the terms “comprising,” “including,” “having,” and the like, as used with respect to embodiments of the present disclosure, are synonymous.

“Coupled” as used herein means that two or more elements are in direct physical contact, or that two or more elements indirectly physically contact each other, but yet still cooperate or interact with each other (i.e., one or more other elements are coupled or connected between the elements that are said to be coupled with each other). The term “directly coupled” means that two or more elements are in direct contact.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 107 Siemens per meter (S/m) at 20 degrees Celsius. Examples of such materials include Cu, Ag, Al, Au, W, Zn and Ni.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors—BJT PNP/NPN, BiCMOS, CMOS, eFET, etc., may be used without departing from the scope of the disclosure. The term “MN” indicates an n-type transistor (e.g., NMOS, NPN BJT, etc.) and the term “MP” indicates a p-type transistor (e.g., PMOS, PNP BJT, etc.).

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

### EXAMPLES

Some non-limiting example embodiments are set forth below.

Example 1 includes a receptacle of a photonics package comprising: a plug portion to receive therein an optical plug such that the optical plug and the plug portion are fixed with respect to one another, the optical plug including a plug side lens assembly; a lens portion to support a die side lens assembly, the lens portion configured such that the die side lens assembly and the plug side lens assembly are aligned to one another when the optical plug is received in the plug portion; and a photonics integrated circuit (PIC) portion to be bonded to a PIC that includes waveguides, the PIC portion configured such that, when the PIC is bonded thereto, the waveguides of the PIC are aligned to: corresponding lenses of the die side lens assembly; and corresponding lenses of the plug side lens assembly when the optical plug is received in the plug portion, wherein the plug portion, the lens portion and the PIC portion together form a rigid body of the receptacle.

Example 2 includes the subject matter of Example 1, wherein the die side lens assembly one of includes a housing that is unitary with the lens portion or is bonded to the lens portion.

Example 3 includes the subject matter of Example 1, wherein the body of the receptacle includes at least one of visual or mechanical fiducials thereon to align at least one of: the optical plug with the plug portion; the die side lens assembly to the lens portion; the PIC to the PIC portion; or the PIC to the die side lens assembly.

Example 4 includes the subject matter of Example 3, wherein the fiducials to align the optical plug with the plug portion include a tongue or groove of the plug portion to engage with a corresponding groove or tongue of the optical plug.

Example 5 includes the subject matter of Example 1, wherein the lens portion is to support a plurality of die side lens assemblies, the plug portion is to support a plurality of optical plugs including a respective plurality of plug side lens assemblies, and the PIC portion is to support a plurality of PICS, wherein individual triads of a die side lens assembly of the plurality of die side lens assemblies, a plug side lens assembly of the plurality of plug side lens assemblies, and a PIC of the plurality of PICS are to be aligned to one another.

Example 6 includes the subject matter of Example 1, wherein the lens portion is disposed between the plug portion and the PIC portion.

Example 7 includes the subject matter of Example 1, wherein the body of the receptacle includes at least one of an ultraviolet transparent material or a metal.

Example 8 includes a receptacle assembly of a photonics package comprising: a photonics integrated circuit (PIC) including waveguides thereon; a die side lens assembly; and a rigid receptacle body including: a plug portion to receive therein an optical plug such that the optical plug and the plug portion are fixed with respect to one another, the optical plug including a plug side lens assembly; a lens portion supporting the die side lens assembly, the lens portion configured such that the die side lens assembly and the plug side lens assembly are aligned to one another when the optical plug is received in the plug portion; and a PIC portion bonded to the PIC such that the waveguides of the PIC are aligned to: corresponding lenses of the die side lens assembly; and corresponding lenses of the plug side lens assembly when the optical plug is received in the plug portion.

Example 9 includes the subject matter of Example 8, wherein the die side lens assembly one of includes a housing that is unitary with the lens portion or is bonded to the lens portion.

Example 10 includes the subject matter of Example 9, further including epoxy bonding the die side lens assembly to the lens portion, wherein the epoxy is at a side of the die side lens assembly that does not include lenses.

Example 11 includes the subject matter of Example 8, wherein the body of the receptacle includes at least one of visual or mechanical fiducials thereon to align at least one of: the optical plug with the plug portion; the die side lens assembly to the lens portion; the PIC to the PIC portion; or the PIC to the die side lens assembly.

Example 12 includes the subject matter of Example 11, wherein the fiducials to align the optical plug with the plug portion include a tongue or groove of the plug portion to engage with a corresponding groove or tongue of the optical plug.

Example 13 includes the subject matter of Example 8, wherein individual ones of the PIC and the die side lens assembly include at least one of visual or mechanical fiducials thereon to align at least one of: the die side lens assembly to the lens portion; the PIC to the PIC portion; or the PIC to the die side lens assembly.

Example 14 includes the subject matter of Example 8, wherein the die side lens assembly includes a plurality of die side lens assemblies, the optical plug includes a plurality of optical plugs having corresponding plug side lens assemblies, and the PIC includes a plurality of PICs, wherein individual triads of a die side lens assembly of the plurality of die side lens assemblies, a plug side lens assembly of the plurality of plug side lens assemblies, and a PIC of the plurality of PICS are aligned to one another.

Example 15 includes the subject matter of Example 8, wherein the die side lens assembly is disposed between the plug portion and the PIC.

Example 16 includes the subject matter of Example 8, wherein individual ones of the die side lens assembly and the plug side lens assembly include a plurality of lens arrays, the lens arrays to be aligned to the waveguides of the PIC.

Example 17 includes the subject matter of Example 8, further including an adhesive bonding the PIC to the body of the receptacle.

Example 18 includes the subject matter of Example 17, wherein the body of the receptacle includes an ultraviolet (UV) transparent material, and the adhesive includes a UV adhesive.

Example 19 includes the subject matter of Example 17, wherein the body of the receptacle includes a metal, and the adhesive includes a high temperature solder.

Example 20 includes a photonics package including: a substrate; one or more processors bonded to and electrically coupled to the substrate; and a receptacle assembly supported on the substrate, the receptacle assembly including: a photonics integrated circuit (PIC) including waveguides thereon, the PIC electrically coupled to conductive traces of the substrate and coupled to the one or more processors to communicate signals therewith; a die side lens assembly; and a rigid receptacle body bonded to the substrate and including: a plug portion to receive therein an optical plug such that the optical plug and the plug portion are fixed with respect to one another, the optical plug including a plug side lens assembly; a lens portion supporting the die side lens assembly, the lens portion configured such that the die side lens assembly and the plug side lens assembly are aligned to one another when the optical plug is received in the plug portion; and a PIC portion bonded to the PIC such that the waveguides of the PIC are aligned to: corresponding lenses of the die side lens assembly; and corresponding lenses of the plug side lens assembly when the optical plug is received in the plug portion.

Example 21 includes the subject matter of Example 20, wherein the die side lens assembly one of includes a housing that is unitary with the lens portion or is bonded to the lens portion.

Example 22 includes the subject matter of Example 21, further including epoxy bonding the die side lens assembly to the lens portion, wherein the epoxy is at a side of the die side lens assembly that does not include lenses.

Example 23 includes the subject matter of Example 20, wherein the body of the receptacle includes at least one of visual or mechanical fiducials thereon to align at least one of: the optical plug with the plug portion; the die side lens assembly to the lens portion; the PIC to the PIC portion; or the PIC to the die side lens assembly.

Example 24 includes the subject matter of Example 23, wherein the fiducials to align the optical plug with the plug portion include a tongue or groove of the plug portion to engage with a corresponding groove or tongue of the optical plug.

Example 25 includes the subject matter of Example 20, wherein individual ones of the PIC and the die side lens assembly include at least one of visual or mechanical fiducials thereon to align at least one of: the die side lens assembly to the lens portion; the PIC to the PIC portion; or the PIC to the die side lens assembly.

Example 26 includes the subject matter of Example 20, wherein the die side lens assembly includes a plurality of die side lens assemblies, the optical plug includes a plurality of optical plugs having corresponding plug side lens assemblies, and the PIC includes a plurality of PICs, wherein individual triads of a die side lens assembly of the plurality of die side lens assemblies, a plug side lens assembly of the plurality of plug side lens assemblies, and a PIC of the plurality of PICS are aligned to one another.

Example 27 includes the subject matter of Example 20, wherein the die side lens assembly is disposed between the plug portion and the PIC.

Example 28 includes the subject matter of Example 20, wherein individual ones of the die side lens assembly and the plug side lens assembly include a plurality of lens arrays, the lens arrays to be aligned to the waveguides of the PIC.

Example 29 includes the subject matter of Example 20, further including an adhesive bonding the PIC to the body of the receptacle.

Example 30 includes the subject matter of Example 29, wherein the body of the receptacle includes an ultraviolet (UV) transparent material, and the adhesive includes a UV adhesive.

Example 31 includes the subject matter of Example 29, wherein the body of the receptacle includes a metal, and the adhesive includes a high temperature solder.

Example 32 includes a method of making a receptacle assembly including: providing a rigid receptacle body including: a plug portion to receive therein an optical plug such that the optical plug and the plug portion are fixed with respect to one another, the optical plug including a plug side lens assembly; a lens portion; and a photonics integrated circuit (PIC) portion; providing a die side lens assembly on the lens portion such that the die side lens assembly and the plug side lens assembly are aligned to one another when the optical plug is received in the plug portion; bonding a PIC that includes waveguides to the PIC portion such that the waveguides are aligned to: corresponding lenses of the die side lens assembly; and corresponding lenses of the plug side lens assembly when the optical plug is received in the plug portion.

Example 33 includes the subject matter of Example 32, wherein the die side lens assembly one of includes a housing that is unitary with the lens portion or is bonded to the lens portion.

Example 34 includes the subject matter of Example 33, further including bonding the die side lens assembly to the lens portion using epoxy, wherein the epoxy is at a side of the die side lens assembly that does not include lenses.

Example 35 includes the subject matter of Example 32, further including using at least one of visual or mechanical fiducials on the body of the receptacle to align at least one of: the optical plug with the plug portion; the die side lens assembly to the lens portion; the PIC to the PIC portion; or the PIC to the die side lens assembly.

Example 36 includes the subject matter of Example 35, wherein the fiducials to align the optical plug with the plug portion include a tongue or groove of the plug portion to engage with a corresponding groove or tongue of the optical plug.

Example 37 includes the subject matter of Example 32, further including using at least one of visual or mechanical fiducials on individual ones of the PIC and the die side lens assembly to align at least one of: the die side lens assembly to the lens portion; the PIC to the PIC portion; or the PIC to the die side lens assembly.

Example 38 includes the subject matter of Example 32, wherein the die side lens assembly includes a plurality of die side lens assemblies, the optical plug includes a plurality of optical plugs have corresponding plug side lens assemblies, and the PIC includes a plurality of PICs, the method including aligning to one another components within individual triads of a die side lens assembly of the plurality of die side lens assemblies, a plug side lens assembly of the plurality of plug side lens assemblies, and a PIC of the plurality of PICS.

Example 39 includes the subject matter of Example 32, further including disposing the die side lens assembly between the plug portion and the PIC.

Example 40 includes the subject matter of Example 32, wherein individual ones of the die side lens assembly and the plug side lens assembly include a plurality of lens arrays, the method including aligning the lens arrays to the waveguides of the PIC.

Example 41 includes the subject matter of Example 32, further including using an adhesive to bond the PIC to the body of the receptacle.

Example 42 includes the subject matter of Example 41, wherein the body of the receptacle includes an ultraviolet (UV) transparent material, and the adhesive includes a UV adhesive.

Example 43 includes the subject matter of Example 41, wherein the body of the receptacle includes a metal, and the adhesive includes a high temperature solder.

Example 44 includes the subject matter of Example 32, wherein providing the receptacle body includes providing a wafer of a plurality of receptacle bodies, and bonding the PIC includes bonding a plurality of PICs to corresponding ones of the plurality of receptacle bodies.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

What is claimed is:

1. A receptacle of a photonics package comprising:
a plug portion to receive therein an optical plug such that the optical plug and the plug portion are fixed with respect to one another, the optical plug including a plug side lens assembly;
a lens portion to support a die side lens assembly, the lens portion configured such that the die side lens assembly and the plug side lens assembly are aligned to one another when the optical plug is received in the plug portion; and
a photonics integrated circuit (PIC) portion to be bonded to a PIC that includes waveguides, the PIC portion configured such that, when the PIC is bonded thereto, the waveguides of the PIC are aligned to:
corresponding lenses of the die side lens assembly; and
corresponding lenses of the plug side lens assembly when the optical plug is received in the plug portion, wherein the plug portion, the lens portion and the PIC portion together form a rigid body of the receptacle.

2. The receptacle of claim 1, wherein the die side lens assembly one of includes a housing that is unitary with the lens portion or is bonded to the lens portion.

3. The receptacle of claim 1, wherein the body of the receptacle includes at least one of visual or mechanical fiducials thereon to align at least one of:
the optical plug with the plug portion;
the die side lens assembly to the lens portion;
the PIC to the PIC portion; or
the PIC to the die side lens assembly.

4. The receptacle of claim 3, wherein the fiducials to align the optical plug with the plug portion include a tongue or groove of the plug portion to engage with a corresponding groove or tongue of the optical plug.

5. The receptacle of claim 1, wherein the lens portion is to support a plurality of die side lens assemblies, the plug portion is to support a plurality of optical plugs including a respective plurality of plug side lens assemblies, and the PIC portion is to support a plurality of PICS, wherein individual triads of a die side lens assembly of the plurality of die side lens assemblies, a plug side lens assembly of the plurality of plug side lens assemblies, and a PIC of the plurality of PICS are to be aligned to one another.

6. The receptacle of claim 1, wherein the lens portion is disposed between the plug portion and the PIC portion.

7. The receptacle of claim 1, wherein the body of the receptacle includes at least one of an ultraviolet transparent material or a metal.

8. A receptacle assembly of a photonics package comprising:
a photonics integrated circuit (PIC) including waveguides thereon;
a die side lens assembly; and
a rigid receptacle body including:
a plug portion to receive therein an optical plug such that the optical plug and the plug portion are fixed with respect to one another, the optical plug including a plug side lens assembly;
a lens portion supporting the die side lens assembly, the lens portion configured such that the die side lens assembly and the plug side lens assembly are aligned to one another when the optical plug is received in the plug portion; and
a PIC portion bonded to the PIC such that the waveguides of the PIC are aligned to:
corresponding lenses of the die side lens assembly; and
corresponding lenses of the plug side lens assembly when the optical plug is received in the plug portion.

9. The receptacle assembly of claim 8, wherein the die side lens assembly one of includes a housing that is unitary with the lens portion or is bonded to the lens portion.

10. The receptacle assembly of claim 9, further including epoxy bonding the die side lens assembly to the lens portion, wherein the epoxy is at a side of the die side lens assembly that does not include lenses.

11. The receptacle assembly of claim 8, wherein the body of the receptacle includes at least one of visual or mechanical fiducials thereon to align at least one of:
the optical plug with the plug portion;
the die side lens assembly to the lens portion;
the PIC to the PIC portion; or
the PIC to the die side lens assembly.

12. The receptacle assembly of claim 8, wherein individual ones of the PIC and the die side lens assembly include at least one of visual or mechanical fiducials thereon to align at least one of:
the die side lens assembly to the lens portion;
the PIC to the PIC portion; or
the PIC to the die side lens assembly.

13. The receptacle assembly of claim 8, wherein the die side lens assembly includes a plurality of die side lens assemblies, the optical plug includes a plurality of optical plugs having corresponding plug side lens assemblies, and the PIC includes a plurality of PICs, wherein individual triads of a die side lens assembly of the plurality of die side lens assemblies, a plug side lens assembly of the plurality of plug side lens assemblies, and a PIC of the plurality of PICS are aligned to one another.

14. The receptacle assembly of claim 8, wherein individual ones of the die side lens assembly and the plug side lens assembly include a plurality of lens arrays, the lens arrays to be aligned to the waveguides of the PIC.

15. The receptacle assembly of claim 8, further including an adhesive bonding the PIC to the body of the receptacle.

16. The receptacle assembly of claim 15, wherein the body of the receptacle includes an ultraviolet (UV) transparent material, and the adhesive includes a UV adhesive.

17. The receptacle assembly of claim 15, wherein the body of the receptacle includes a metal, and the adhesive includes a high temperature solder.

18. A photonics package including:
a substrate;
one or more processors bonded to and electrically coupled to the substrate; and
a receptacle assembly supported on the substrate, the receptacle assembly including:
a photonics integrated circuit (PIC) including waveguides thereon, the PIC electrically coupled to conductive traces of the substrate and coupled to the one or more processors to communicate signals therewith;
a die side lens assembly; and
a rigid receptacle body bonded to the substrate and including:
a plug portion to receive therein an optical plug such that the optical plug and the plug portion are fixed with respect to one another, the optical plug including a plug side lens assembly;
a lens portion supporting the die side lens assembly, the lens portion configured such that the die side lens assembly and the plug side lens assembly are aligned to one another when the optical plug is received in the plug portion; and
a PIC portion bonded to the PIC such that the waveguides of the PIC are aligned to:
corresponding lenses of the die side lens assembly; and
corresponding lenses of the plug side lens assembly when the optical plug is received in the plug portion.

19. The photonics package of claim 18, wherein the die side lens assembly one of includes a housing that is unitary with the lens portion or is bonded to the lens portion.

20. The photonics package of claim 19, further including epoxy bonding the die side lens assembly to the lens portion, wherein the epoxy is at a side of the die side lens assembly that does not include lenses.

21. The photonics package of claim 18, wherein the body of the receptacle includes at least one of visual or mechanical fiducials thereon to align at least one of:
the optical plug with the plug portion;
the die side lens assembly to the lens portion;
the PIC to the PIC portion; or
the PIC to the die side lens assembly.

22. The photonics package of claim 18, wherein individual ones of the PIC and the die side lens assembly include at least one of visual or mechanical fiducials thereon to align at least one of:
the die side lens assembly to the lens portion;
the PIC to the PIC portion; or
the PIC to the die side lens assembly.

23. A method of making a receptacle assembly including:
providing a rigid receptacle body including:
a plug portion to receive therein an optical plug such that the optical plug and the plug portion are fixed with respect to one another, the optical plug including a plug side lens assembly;
a lens portion; and
a photonics integrated circuit (PIC) portion;
providing a die side lens assembly on the lens portion such that the die side lens assembly and the plug side lens assembly are aligned to one another when the optical plug is received in the plug portion;
bonding a PIC that includes waveguides to the PIC portion such that the waveguides are aligned to:
corresponding lenses of the die side lens assembly; and
corresponding lenses of the plug side lens assembly when the optical plug is received in the plug portion.

24. The method of claim 23, further including:
using at least one of visual or mechanical fiducials on the body of the receptacle to align at least one of:
the optical plug with the plug portion;
the die side lens assembly to the lens portion;
the PIC to the PIC portion; or
the PIC to the die side lens assembly; and
using at least one of visual or mechanical fiducials on individual ones of the PIC and the die side lens assembly to align at least one of:
the die side lens assembly to the lens portion;
the PIC to the PIC portion; or
the PIC to the die side lens assembly.

25. The method of claim 23, wherein providing the receptacle body includes providing a wafer of a plurality of receptacle bodies, and bonding the PIC includes bonding a plurality of PICs to corresponding ones of the plurality of receptacle bodies.
